(19) United States
(12) Patent Application Publication
(10) Pub. No.: US 2005/0020326 A1
(43) Pub. Date: Jan. 27, 2005

(54) Portable electronic communication device

(76) Inventors: Jensen Lee, Sindian City (TW); San-Chi Ho, Yunghe City (TW)

Correspondence Address: RABIN & Berdo, PC, 1101 14TH STREET, NW, SUITE 500, WASHINGTON, DC, 20005, US

(21) Appl. No.: 10/748,260

(22) Filed: Dec. 31, 2003

(30) Foreign Application Priority Data
Jul. 24, 2003 (TW) 92213553

(51) Int. Cl. H04M 1/00

(52) U.S. Cl. 455/575.3

(57) ABSTRACT

A portable electronic communication device (110) includes a base (150), a cover (160), and a receiver (118). The base (150) has a front surface (150a). The cover is mounted to the base in such a way that the cover can be folded upon, unfolded from, and turned around the base. The cover has a compartment (180), a front surface (160a) and a rear surface (160b). The front surface and the rear surface of the cover have a number of first apertures (124a) and a number of second apertures (124b) respectively, and the compartment communicates with an outside of the cover through the first apertures and the second apertures. The receiver is deposited in the compartment between the first apertures and the second apertures. Sound generated by the receiver can radiate out of the cover through the second apertures or the first apertures of the cover while the cover is folded upon the base in such a way that the front surface or the rear surface of the cover rests on the front surface of the base.

This application claims the benefit of Taiwan Patent Application Serial No. 92213553, filed Jul. 24, 2003.

### BACKGROUND OF THE INVENTION

1. Field of the Invention

The invention relates in general to a portable electronic communication device, and more particularly to a portable electronic communication device having a receiver that allows sound to radiate out of a cover of the device from both sides of the cover so that a user of the device can hear voice information of the device by approaching his (her) ear to either one of the both sides of the cover.

2. Description of the Related Art

In the technology-advanced era nowadays, portable electronic communication devices have become an indispensable part of the day-to-day life of modern people. The types of portable electronic communication devices are many, for example, wireless personal digital assistants (PDAs) and mobile phones. A user can, for example, use a wireless PDA to make and receive phone calls, to memo a note, to edit an address book, to look up a dictionary, and to listen to music. The presence of portable electronic communication devices really makes the life of modern people easier, and reduces the gap of communication between people.

Please refer to FIG. 1 that is a diagram of a traditional wireless PDA 10. In FIG. 1, the wireless PDA 10 includes a case 12, a touch display panel 14, a stylus 15, a microphone 16, a receiver 18, a speaker 20, and several operating buttons 22. The case 12 includes a stylus slot 30, a front surface 12a, and top and bottom surfaces 12b and 12c. The front surface 12a of the case 12 is connected to the top and bottom surfaces 12b and 12c of the case 12. The opening of the stylus slot 30 is located in the top surface 12b of the case 12, and the stylus slot 30 is used for accommodating the stylus 15. The touch display panel 14 and the operating buttons 22 are located on the front surface 12a of the case 12, whereas the microphone 16, the receiver 18, and the speaker 20 are located inside the case 12. Several apertures 24, 26, and 28 are located in the front surface 12a of the case 12; the apertures 28 are used for the microphone 16 to receive voice from a user of the wireless PDA 10, and the apertures 24 and 26 are used for allowing the sound from the receiver 18 and the speaker 20 respectively to radiate out of the case 12.

The user can use the stylus 15 to activate the touch display panel 14 to enter text and commands or use the operating buttons 22 to enter commands. The user can use the microphone 16 and the receiver 18 to talk to and listen to a phone call when the wireless PDA is in a phone mode. The user can even use the speaker 20 to play the voice of the calling party out during the phone call.

The technology for the receiver 18 to create sound is based on both the magnet and the air compression that make the receiver diaphragm vibrate. Receivers nowadays are usually dipolar; it means that the receiver creates positive and negative phase sound waves simultaneously. Due to the fact that the positive phase and negative phase of sound waves interfere with each other, the manufactures have to use a special technique to allow the receiver 18 to output only the positive phase sound that radiates out of the case 12 through the apertures 24. If the PDA is to be made capable of giving off sound on both sides, the manufactures need to use two receivers to solve the interference problem of the positive and the negative phase of the sound waves. In doing so, the cost of manufacturing and the size of the wireless PDA 10 are increased.

### SUMMARY OF THE INVENTION

It is therefore an object of the invention to provide a portable electronic communication device, which is designed to have a single receiver received in a cover of the device. Two sets of apertures are defined in opposite surfaces of the cover around the receiver. Such a design allows the user to listen to a phone call when the cover is folded upon a base of the device and faces either forwardly or rearwardly to thereby increase the usability of the device.

The invention achieves the above-identified object by providing a portable electronic communication device that includes a base, a cover having front and rear surfaces and a compartment between the front and rear surfaces, and a receiver. The cover is mounted to the base in such a way that the cover can be both folded and swiveled relative to the base so that the cover can lie on the base with the front surface or the rear surface of the cover facing toward the base. The front surface and the rear surface of the cover have a number of first apertures and a number of second apertures respectively, and the compartment communicates with an outside of the cover through the first apertures and the second apertures. The receiver is deposited in the compartment between the first apertures and the second apertures and is used as a means for transmitting voice information to the user of the portable electronic communication device, while the cover is folded upon the base in such a way that the front surface or the rear surface of the cover faces the base. The sound produced from the receiver radiates out of the cover through the second apertures or the first apertures of the cover so that the user of the device can hear the voice information by approaching his (her) ear to the front face or the rear face of the cover.

The invention achieves the above-identified object also by providing a wireless personal digital assistant (PDA) that includes a base, a cover, and a receiver. The base has a front surface and the cover is deposited on the base in such a way that the cover can be folded upon, unfolded from, and swiveled about the base. The cover has a compartment, a front surface and a rear surface. The front surface and the rear surface of the cover have a number of first apertures and a number of second apertures respectively, and the compartment communicates with an outside of the cover through the first apertures and the second apertures. The first apertures have a total cross-sectional area which substantially the same as that of the second apertures. The receiver is deposited in the compartment for dividing the compartment into a first sub-compartment and a second sub-compartment. The first and second sub-compartments have substantially the same volume. Furthermore, the first sub-compartment and the second sub-compartment communicate with the outside of the cover through the first apertures and the second apertures respectively. The receiver is used as a means for transmitting voice information of the wireless PDA to a user thereof, while the cover is folded upon the base in such a way that the front surface or the rear surface of the cover faces the front surface of the base. The sound produced from the receiver could radiate out of the cover through the second apertures or the first apertures of the cover.

The invention achieves the above-identified object also by providing a wireless personal digital assistant (PDA) that includes a base, a cover, and a receiver. The cover is deposited on the base in such a way that cover can be folded upon, unfolded from, and turned around the base. The receiver is deposited inside the cover for producing sound that can be heard by a user by approaching his (her) ear to front or rear surface of the cover.

Other objects, features, and advantages of the invention will become apparent from the following detailed description of the preferred but non-limiting embodiments. The following description is made with reference to the accompanying drawings.

### BRIEF DESCRIPTION OF THE DRAWINGS

FIG. 1 is a diagram of a traditional wireless PDA.

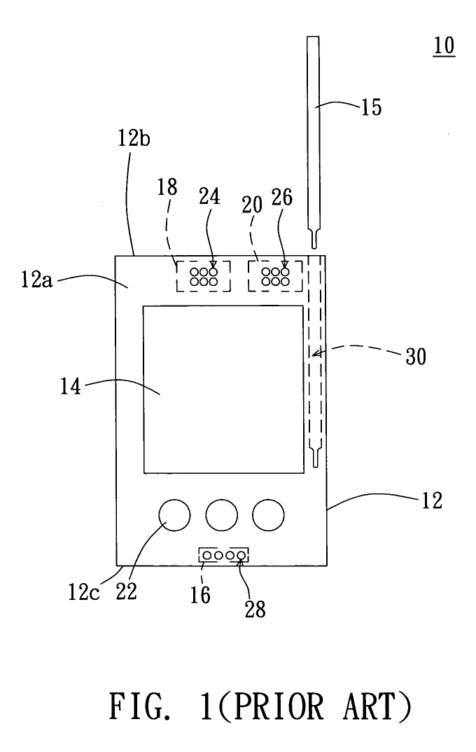

FIG. 2 is a 3-D diagram showing a portable electronic communication device according to the present invention in a first folded status.

FIG. 3 is a 3-D diagram showing that the portable electronic communication device according to the present invention is unfolded from the position of FIG. 2.

FIG. 4 is an enlarged cross-sectional view taken along line 4-4′ of FIG. 2.

FIG. 5 is a 3-D diagram showing that the cover has been turned an angle relative to the base from the position of FIG. 3.

FIG. 6 is a 3-D diagram showing that the cover is further turned an angle from the position of FIG. 5.

FIG. 7 is a 3-D diagram showing that the cover is folded upon the base from the position of FIG. 6 so that the portable communication device according to the present invention moves from the first folded status of FIG. 2 to reach a second folded status.

FIG. 8 is an enlarged cross-sectional view taken along line 8-8′ of FIG. 7.

### DETAILED DESCRIPTION OF THE INVENTION

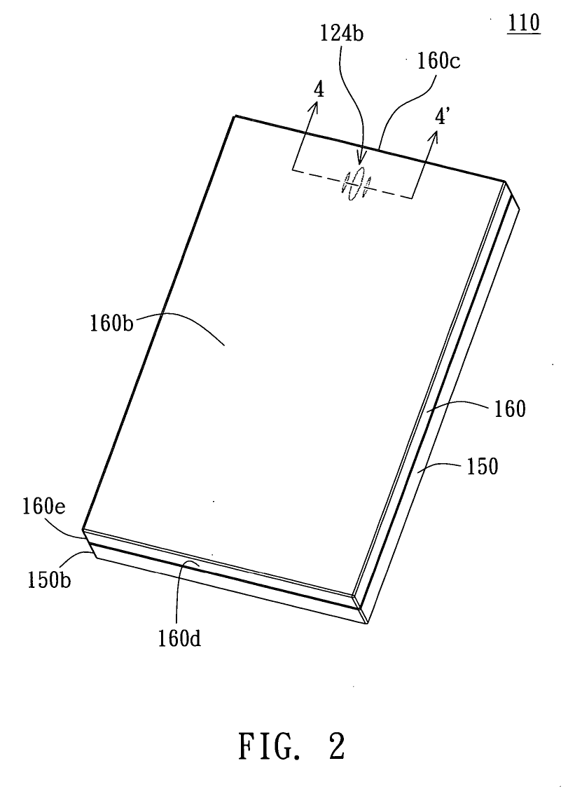

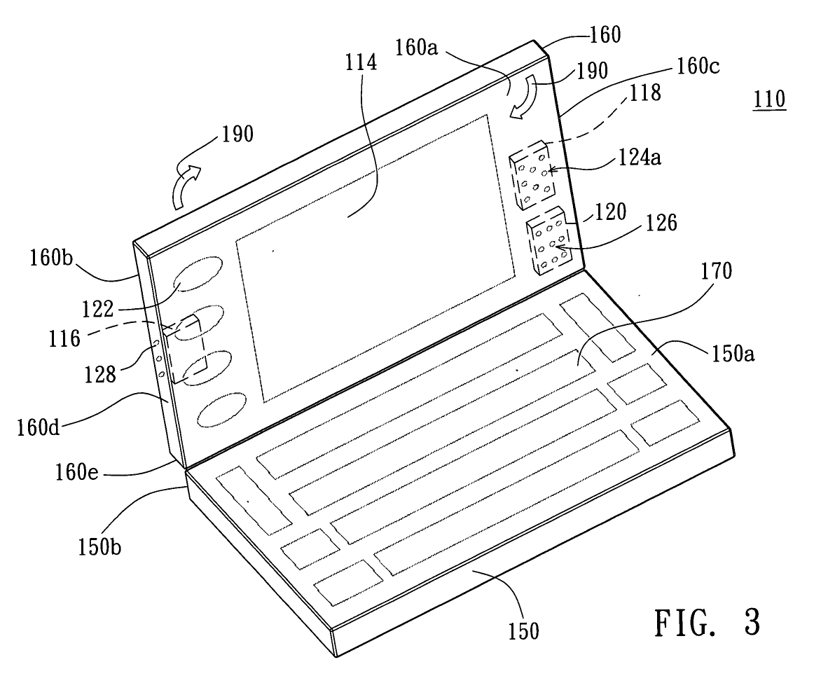

Please refer to FIG. 2 and FIG. 3; they are 3-D diagrams showing a portable electronic communication device 110 according to the present invention in folded and unfolded positions, respectively. In FIG. 2 and FIG. 3, the portable electronic communication device 110 includes a base 150, a cover 160, a receiver 118, a touch display panel 114, several operating buttons 122, a microphone 116, a speaker 120, and a keyboard 170. The base 150 consists of a front surface 150a and a lateral surface 150b. The front surface 150a is connected to the lateral surface 150b. The keyboard 170 is located on the front surface 150a of the base 150 and is used for entering commands and editing texts. The keyboard 170 according to the present invention is a QWERTY keyboard. The cover 160 consists of a front surface 160a, a rear surface 160b, and three lateral surfaces 160c, 160d, and 160e. The lateral surface 160e is connected to the opposite lateral surfaces 160c and 160d, and the lateral surfaces 160c, 160d, and 160e are used for connecting the front surface 160a and the rear surface 160b of the cover 160. The method how the cover 160 is manipulated to make the front surface 160a or the rear surface 160b of the cover 160 rests against the front surface 150a of the base 150 will be described below.

The invention offers a hinge and swivel device (not shown in the drawing) that connects the lateral surface 160e of the cover 160 to the lateral surface 150b of the base 150 so that the cover 160 can be folded and swivelled relative to the base 150. Since such a hinge and swivel device is well known to a person skilled in the art, and widely used in some notebooks and mobile phones, detailed description thereof is omitted here. Furthermore, the front surface 160a of the cover 160 has a number of apertures 124a and 126 near the lateral surface 160c, and the lateral surface 160d of the cover 160 has a number of apertures 128, as shown in FIG. 3. The rear surface 160b of the cover 160 has a number of apertures 124b near the lateral surface 160c of the cover 160, as shown in FIG. 2. The apertures 124b face in a direction opposite to that the apertures 124a face, and the apertures 124a have a total cross-sectional area, which is substantially equal to that of the apertures 124b.

The touch display panel 114 is deposited on the front surface 160a of the cover 160 and is used for displaying or inputting text or commands when it is activated by a stylus (not shown in the drawings). The operating buttons 122 are located on the front surface 160a of the cover 160 between the touch display panel 114 and the lateral surface 160d of the cover 160, and are used for inputting commands. The microphone 116 is deposited inside the cover 160 between the touch display panel 114 and the lateral surface 160d of the cover 160, and is used for receiving voice of a user of the device 110 via the apertures 128. The speaker 120 is deposited inside the cover 160 between the touch display panel 114 and the lateral surface 160c of the cover 160. When the cover 160 is unfolded from the base 150, the portable electronic communication device 110 uses the speaker 120 as a means to generate voice information to be heard by the user of the device 110. The voice information radiates out of the cover 160 via the apertures 126.

The receiver 118 is deposited inside the cover 160 between the touch display panel 114 and the lateral surface 160c of the cover 160. When the cover 160 is folded upon the base 150, the portable electronic communication device 110 uses the receiver 118 as the means to generate the voice information. The voice information generated by the receiver 118 radiates out of the cover 160 via the apertures 124a or 124b, as detailed in the following description.

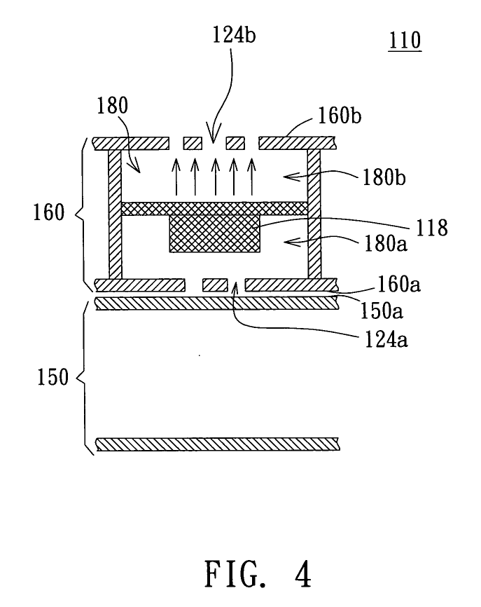

Please refer to FIG. 4 that is an enlarged cross-sectional view taken along line 4-4′ of FIG. 2. As shown in FIG. 4, the cover 160 defines a compartment 180 inside the cover 160 to receive the receiver 118. After the receiver 118 is deposited in the compartment 180, the compartment 180 is divided into two small sub-compartments 180a, 180b. The sub-compartments 180a, 180b have substantially the same volume, and open to the outside of the cover 160 via the apertures 124a and 124b respectively. The cover 160 is folded on the based 150 in such a way that the front surface 160a of the cover 160 rests against the front surface 150a of the base 150 as shown in FIGS. 2 and 4, the sound generated by the receiver 118 radiates out of the cover 160 via the apertures 124b because the apertures 124a are blocked by the front surface 150a of the base 150. Therefore, the user can listen to the sound generated by the receiver 118 by approaching his (her) ear to the apertures 124b when the cover 160 is folded to the base 150 with the front surface 160a of the cover 160 resting against the front face 150a of the cover 150. By the design that the apertures 124a and 124b have substantially the same total cross-sectional area, and the sub-compartments 180a, 180b have substantially the same volume, the voice volume generated by the receiver 118 can be maintained substantially the same level whether the sound is transmitted through the apertures 124a or the apertures 124b.

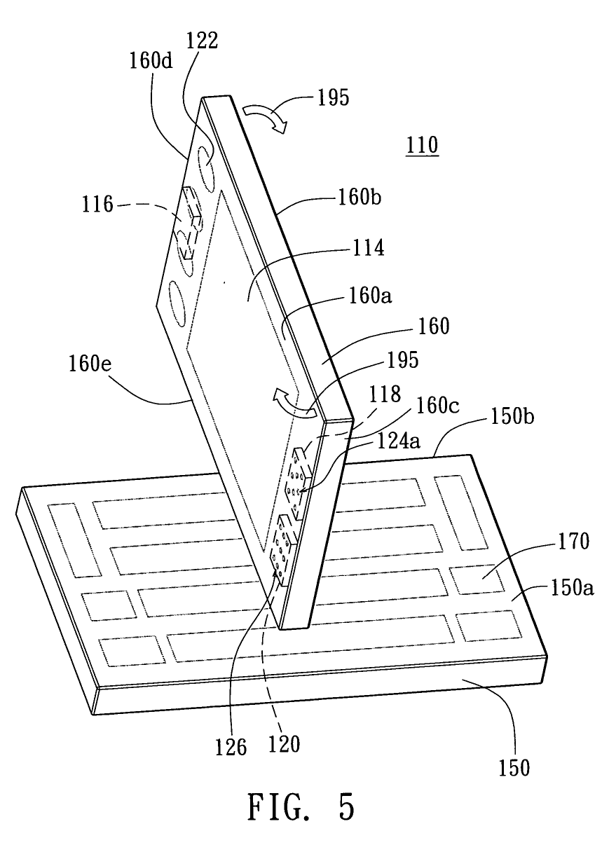

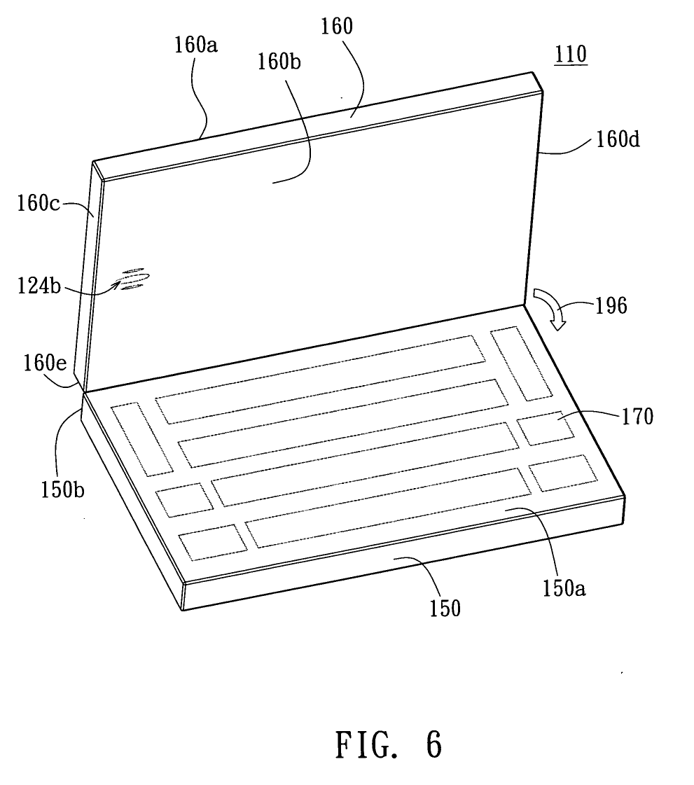

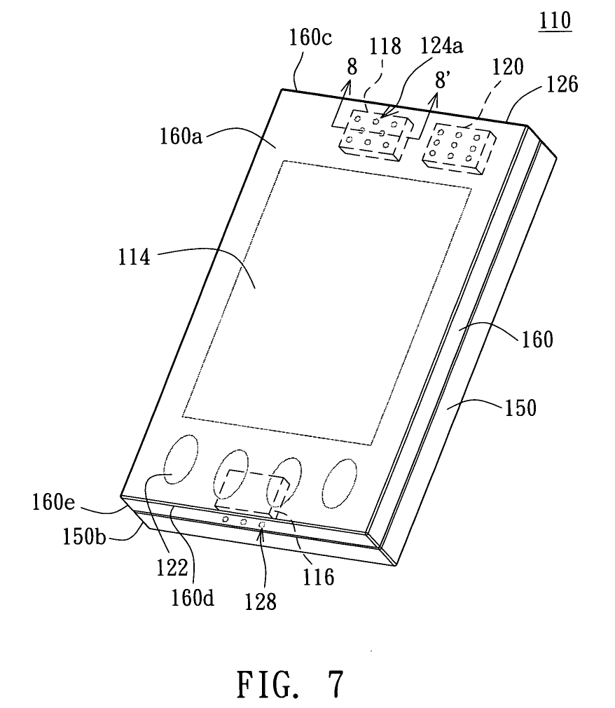

When the user wants to turn the cover 160 upside down relative to the base 150, first, the user has to unfold the cover 160 from the base 150 from the position of FIG. 2 to a position that the cover 160 is perpendicular to the base 150 as shown in FIG. 3. Then, the user can turn the cover 160 according to the direction pointed out by arrows 190 of FIG. 3, and the cover 160 is turned around a central point of the lateral surface 160e of the cover 160 as shown in FIG. 5. When the cover 160 is unfolded from the base 150, the receiver 118 is turned off and the user can use the speaker 120 to listen to the voice information of the device 110. Then, the user can turn the cover 160 according to the direction pointed out by arrows 195 as shown in FIG. 5 until the rear surface 160b of the cover 160 faces the front surface 150a of the base 150 as shown in FIG. 6; that is, the cover 160 is turned 180 degrees from the position of FIG. 3 to the position of FIG. 6. At this moment, the user can still use the speaker 120 to listens to the voice information of the device 110. Finally, the user can fold the cover 160 according to the direction pointed out by an arrow 196 in FIG. 6 until rear surface 160b of the cover 160 rests on the front surface 150a of the base 150 as shown in FIG. 7. In FIG. 7, the rear surface 160b of the cover 160 rests against the front surface 150a of the base 150 and the front surface 160a of the cover 160 faces in a direction away from the front surface 150a of the base 150. At the position of FIG. 7, the speaker 120 is turned off, and the device 110 can be easily inputted with commands or text by using the stylus to activate the touch display panel 114 and operating the buttons 122.

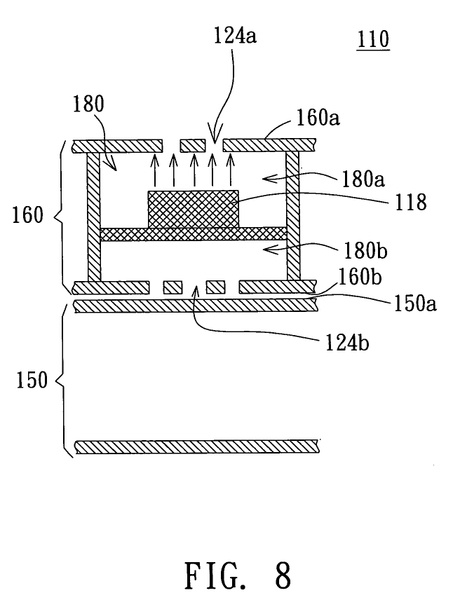

Please refer to FIG. 8 that is an enlarged cross-sectional view taken along line 8-8′ of FIG. 7. At this position, the receiver 118 is turned on and the speaker 120 is turn off, and the sound of the receiver 118 radiates to the outside of the cover 160 via the apertures 124a because the apertures 124b are blocked by the front surface 150a of the base 150. So, the user can listen to the voice information of the device by approaching his (her) ear to the apertures 124a. To return the cover 160 from the position of FIG. 7 to the position of FIG. 2, the user needs to reverse the operations as mentioned above.

The portable electronic communication device 110 according to the invention can be implemented as a wireless personally digital assistant (wireless PDA) or a smart phone. Furthermore, the touch display panel can be a liquid crystal display panel (LCD panel) or an organic light emitting diode (OLED). The device 110 can form a slot (not shown in the drawings) in the base 150 or the cover 160 to accommodate the stylus.

The design of the present invention has advantages that the user can hear voice information by approaching his (her) ear to the front or rear surface of the cover in which only one receiver is equipped. Therefore, the usability of the communication device is enhanced without increasing the cost thereof. Furthermore, when the cover is unfolded from the base, the speaker is turned on by which the phone function of the device 110 can still work when the user uses the device 110 for other function such as schedule editing.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

1. A portable electronic communication device comprising:
a base having a front surface;
a cover, which is mounted to the base in such a way that the cover can be folded upon, unfolded from, and turned around the base, wherein the cover has a compartment, a front surface, and a rear surface, wherein the front surface and the rear surface of the cover have a plurality of first apertures and a plurality of second apertures respectively, and the compartment communicates with an outside of the cover through the first apertures and the second apertures; and
a receiver deposited in the compartment between the first apertures and the second apertures, wherein sound generated by the receiver can be transmitted through the first or second apertures when the cover is folded upon the base in such a way that the front surface or the rear surface of the cover rests against the front surface of the base.

2. The portable electronic communication device according to claim 1, wherein the first apertures have a total cross-sectional area, which is substantially the same as that of the second apertures.

3. The portable electronic communication device according to claim 1, wherein the receiver divides the compartment into a first sub-compartment and a sub-second compartment, the first sub-compartment and the second sub-compartment communicate with the outside of the cover through the first apertures and the second apertures respectively, and the first sub-compartment has a volume which is substantially equal to that of the second sub-compartment.

4. The portable electronic communication device according to claim 1 further comprising a display panel deposited on the front surface of the cover for displaying data of the device.

5. The portable electronic communication device according to claim 1, wherein the display panel is a touch display panel adapted to be activated by a stylus.

6. The portable electronic communication device according to claim 1 further comprising an operating button for inputting command.

7. The portable electronic communication device according to claim 1 further comprising a microphone deposited inside the cover for receiving voice of a user of the device.

8. The portable electronic communication device according to claim 1 further comprising a speaker deposited inside the cover, the speaker generating sound while the cover is unfolded from the base.

9. The portable electronic communication device according to claim 1 further comprising a keyboard deposited on the front surface of the base for inputting data or command.

10. A portable electronic communication device comprising:
a base;
a cover mounted to the base in such a way that the cover can be folded upon, unfolded from, and turned around the base, the cover having a front surface defining at least a first aperture and a rear surface defining at least a second aperture;
a display mounted in the cover;
a receiver deposited inside the cover wherein sound generated by the receiver can be transmitted through the at least a first aperture or the at least a second aperture when the cover is folded upon the base.

11. The portable electronic communication device according to claim 10 further comprising a keyboard deposited on the base.

12. The portable electronic communication device according to claim 11, wherein the at least a first aperture has a cross-sectional area which substantially the same as that of the at least a second aperture, and the receiver is received in a compartment in the cover and divides the compartment into two sub-compartments communicating with the at least a first and a second aperture, respectively, the two sub-compartments having substantially the same volume.

13. The portable electronic communication device according to claim 10 further comprising a speaker deposited inside the cover, wherein sound generated by the speaker is transmitted to an outside of the cover when the cover is unfolded from the base.

14. The portable electronic communication device according to claim 10 further comprising a microphone for receiving voice of a user of the device.

15. The portable electronic communication device according to claim 10, wherein the at least a first aperture has a cross-sectional area which is substantially equal to that of the at least a second aperture.

16. The portable electronic communication device according to claim 10, wherein the receiver is deposited inside a compartment in the cover, and divides the compartment into two sub-compartments having substantially the same volume.

17. The portable electronic communication device according to claim 13, wherein the at least a first aperture has a cross-sectional area which is substantially the same as that of the at least a second aperture.

18. The portable electronic communication device according to claim 17, wherein the receiver is deposited inside a compartment in the cover and divides the compartment into two sub-compartments communicating with the at least a first and a second aperture, respectively, the two sub-compartments having substantially the same volume.

19. The portable electronic communication device according to claim 10, wherein the base is equipped with a keyboard, and the cover is further equipped with a microphone for receiving voice from a user of the device.

20. The portable electronic communication device according to claim 19 further comprising a speaker which generates sound when the cover is unfolded from the base.

21. The portable electronic communication device according to claim 20, wherein the display panel is a touch display panel adapted to be activated by a stylus.

22. The portable electronic communication device according to claim 21, wherein the microphone receives the voice of the user through aperture defined in an lateral surface of the cover, said lateral surface being between the front and rear surfaces of the cover.
